(19) United States
(12) Patent Application Publication
(10) Pub. No.: US 2015/0209740 A1
(43) Pub. Date: Jul. 30, 2015

(54) CONTAINER-MIXER

(71) Applicants: SAINT-GOBAIN PERFORMANCE PLASTICS FRANCE, Charny (FR); AMS R&D SAS, Seine Port (FR)

(72) Inventors: Roland Lucotte, Bussieres (FR); Julien Benoit, Manziat (FR); Jean-Baptiste Drevet, Paris (FR); Anthony Diodati, Mullica Hill, NJ (US); Anthony Pagliaro, Lansdale, PA (US)

(21) Appl. No.: 14/603,988

(22) Filed: Jan. 23, 2015

(30) Foreign Application Priority Data
Jan. 24, 2014 (FR) 1450632

(51) Int. Cl. B01F 5/10; B01F 15/00

(52) U.S. Cl. CPC B01F 5/108; B01F 15/00136; B01F 2215/0032

(57) ABSTRACT

A container-mixer including a container designed to receive at least one fluid; and a pump comprising a pump body which defines at least one fluid intake orifice and at least one fluid delivery orifice, wherein the at least one intake orifice and the at least one fluid delivery orifice of the pump body open into the interior of the container such that the fluid circulates directly and without a duct between the container and the pump body, the pump body defining a circulation space for circulation of fluid in a direction of circulation (A) from the at least one inlet orifice of the circulation space towards an outlet orifice of the circulation space, the pump comprising a deformable membrane which is held in the circulation space substantially parallel to the direction of circulation (A), the membrane being actuated so as to vibrate.

### CROSS-REFERENCE TO RELATED APPLICATION

This application claims priority under 35 U.S.C. §119(b) to French Patent Application No. 1450632 entitled “RECIPIENT-MELANGEUR,” by Roland Lucotte, et al., filed Jan. 24, 2014.

### FIELD OF THE DISCLOSURE

The present invention relates to a container-mixer, which is particularly well suited for mixing of fluids which are fragile or filled with particles, such as biological or pharmaceutical fluids.

### RELATED ART

In many industrial processes, it is necessary to mix solutions or suspensions in a controlled manner, in order to ensure a uniform distribution of the components and obtain satisfactory outputs, in particular in the pharmaceuticals industry, the medical field, the food processing industry, or the semiconductors industry, for example in CMP (Chemical-Mechanical Planarization) polishing processes which are designed to planarize the surface of semiconductor components.

In order to mix a solution or a fluid suspension, it is known to use a container with a rotary agitator, in which a rod provided with blades or a turbine is placed in the fluid by passing through an opening in the container, and is rotated by an external motor in order to produce the required mixing action. A disadvantage of the containers with a rotary agitator is that the agitator tends to generate localized pressure and shearing effects in the solution or suspension being mixed, which is particularly disadvantageous for applications which involve fragile components. One application is for example the mixing of suspensions of cells, in particular for the production of pharmaceutical proteins from genetically modified bacterial cells. The suspensions of cells require gentle mixing in order to make the nutrients circulate. However, when the mixing is carried out by a rotary agitator, shearing stresses occur in the suspension, which tend to damage or destroy part of the cells and proteins. This results in a decrease in the output and the appearance of debris in the fluid suspension.

Another disadvantage of containers with a rotary agitator is the risk of contamination or leakage during the mixing. In fact, the rod provided with blades or the turbine passes into the interior of the container through a dynamic seal or bearing. There is then a risk of bacteria or other contaminants entering the container through the dynamic seal, which can damage the product inside the container. There is also a risk that fluids contained in the container will pass to the exterior through the dynamic seal, which is not acceptable in the case of dangerous or toxic fluids. In addition, the presence of dynamic seals, comprising folds which are difficult to reach, complicates the cleaning and sterilization, which poses a problem for the manufacture of sterile solutions.

In order to mix fluids in sterile conditions, a known technique is the use of a magnetic agitator, where a magnetic bar is placed in the container in the vicinity of its base, and is rotated by a magnetic actuator positioned on the exterior of the container. This technique has the advantage of not needing a physical connection or dynamic seals between the mobile part of the agitator and its drive element, thus making it possible to maintain a sterile environment in the container. However, in this device, the magnetic bar is attracted into contact with the base of the container, which causes friction between the bar and the base of the container. This uncontrolled friction generates heat and shearing stresses in the fluid, which are disadvantageous in the presence of fragile components, and in particular biological components. In addition, a magnetic bar agitator does not make it possible to achieve the level of displacement of fluid provided by a turbine, and is not suitable for large volumes.

### BRIEF DESCRIPTION OF EMBODIMENTS

It is these drawbacks that the invention is more particularly intended to overcome, by proposing a container-mixer which allows mixing of fluid which is at the same time efficient and minimizes damage to the components, both for small volumes and for large volumes of fluid, the structure of the container-mixer being preferably designed to facilitate sterile use and limit the risks of contamination, this container-mixer also having a reduced size.

To this end, one subject of the invention is a container-mixer comprising:
a container which is designed to receive at least one fluid; and
a pump comprising a pump body which defines at least one fluid intake orifice and at least one fluid delivery orifice,
   characterized in that the intake and delivery orifices of the pump body open into the interior of the container such that the fluid circulates directly and without a duct between the container and the pump body, the pump body defining a circulation space for circulation of fluid in a direction of circulation from an inlet orifice of the circulation space towards an outlet orifice of the circulation space, the pump comprising a deformable membrane which is held in the circulation space substantially parallel to the direction of circulation, the membrane being actuated so as to vibrate.

Within the meaning of the invention, a fluid is a deformable medium capable of being mixed, such as a liquid, a gas, a gel, a paste, a powder, a suspension, a dispersion, an emulsion, or a mixture thereof. A container-mixer according to the invention can be used in particular for mixing a powder with a liquid, mixing a bioreactor, mixing a suspension, in particular in a CMP polishing process.

According to an embodiment, the membrane is actuated at one end thereof situated on the side of the inlet orifice, so that an undulation of the membrane is propagated from this end to another end of the membrane situated on the side of the outlet orifice.

According to one aspect of the invention, the container-mixer comprises a coupling element adapted to couple the membrane and an actuating device adapted to vibrate the membrane, in particular substantially perpendicular to the direction of circulation.

According to an embodiment, the pump body comprises walls, such as rigid walls, which define between them the circulation space for circulation of fluid in a direction of circulation from an inlet orifice of the circulation space towards an outlet orifice of the circulation space, the membrane being held in the circulation space substantially parallel to the direction of circulation, the container-mixer comprising a coupling element adapted to couple the membrane and an actuating device adapted to generate alternately, at one end of the membrane situated near the inlet orifice of the circulation space, an excitation force substantially perpendicular to the direction of circulation.

According to an embodiment of the invention, the mixing of one or more fluids present in the container is carried out by a vibrating membrane pump. The membrane of the container-mixer according to the invention may be arranged so that in response to application of an excitation force alternately to one end of the membrane, in an excitation direction substantially perpendicular to the membrane, while the membrane extends parallel to the direction of circulation, at least one undulation of the membrane appears and spreads along the membrane from its end subjected to the excitation force towards another end of the membrane.

In an embodiment, the membrane constitutes a support for displacement of waves from its end which is subjected to the excitation force to its other end. The displacement of these waves may be accompanied by forced damping in the fluid circulation space. Transfer of mechanical energy may thus be established between the membrane and the fluid, in the form of a pressure gradient and a fluid flow.

According to an embodiment of the invention, the fluid circulates directly and without a duct between the body of the vibrating membrane pump and the container, thus reducing the risks of contamination and losses of hydraulic power. The use of a vibrating membrane pump may makes it possible to avoid the presence of dynamic seals subjected to stress by a rotary member, which also contributes to reduce the risks of contamination and leakage. In addition, since a vibrating membrane pump generates only a few shearing stresses in the fluid displaced, a container-mixer according to the invention may preserve the integrity of the components of the fluid, while ensuring a significant level of displacement of fluid.

According to a particular embodiment, the excitation of the membrane is carried out at one of the natural frequencies of the membrane, and in particular the first natural frequency of the membrane.

According to an embodiment, in order to avoid localized pressure effects in the fluid, the excitation frequency of the membrane may have a value contained in the range of between 25 Hz and 250 Hz, such as in a range of between 50 Hz and 150 Hz.

At rest, the membrane may be held only at its periphery, which may prevent relaxation of the membrane during storage of the container-mixer. Upon actuation of the membrane, the latter may have its surface increase with the formation of the wave, resulting in a tension of the membrane in operation, due to the membrane being held at the periphery.

According to one feature, the membrane may be kept under tension in the circulation space, where tension is applied in a direction substantially parallel to the direction of circulation. The tension may be imparted by any suitable arrangement causing the return of the membrane to a planar configuration once the membrane is at rest, that is to say not subjected to the alternating excitation force. For example, the periphery of the membrane which is flexible and elastic can be engaged with a peripheral rigid frame of the membrane, this frame exerting at the periphery of the membrane efforts to stretch the membrane and thus force its elastic return in a plane of extension of the frame. In the case of a membrane with discoidal geometry, the frame may in particular be a ring, which exerts at the periphery of the membrane radiating efforts to stretch the membrane.

Within the context of the invention, the membrane can be constituted by any material which is suitable for its purpose. In a particular embodiment, the membrane can include a material selected from silicone elastomers, polyurethane, rubber, any similar polymer, or a combination thereof.

It will be appreciated that several known geometries of membranes are compatible with the invention.

According to one embodiment, the membrane can be in the form of a substantially parallelepiped strip, and can be held in a circulation space which is delimited by two, preferably rigid, walls disposed facing the main surfaces of the membrane. An excitation force substantially perpendicular to the mean plane of the membrane can then be applied to an edge of the membrane which is situated on the side of the inlet orifice of the circulation space, such that the deformation waves are propagated towards an opposite edge of the membrane which is situated on the side of the outlet orifice of the circulation space.

According to another embodiment, the membrane can have a tubular shape, and can be held in a tubular circulation space with preferably rigid walls. A distribution of symmetric radial excitation forces can then be applied to one end of the tubular membrane which is situated on the side of the inlet orifice of the circulation space, such that the deformation waves are propagated towards the opposite end of the membrane which is situated on the side of the outlet orifice of the circulation space.

According to yet another embodiment, the membrane can be in the shape of a disc, or a portion of a disc, and can be held in a circulation space delimited by two, preferably rigid, walls which are disposed facing the main surfaces of the membrane. An excitation force substantially perpendicular to the mean plane of the membrane can then be applied to a first end of the membrane which is situated on the side of the inlet orifice of the circulation space, such that the deformation waves are propagated towards a second end of the membrane which is situated on the side of the outlet orifice of the circulation space. Embodiments having discoidal geometry may simplistically retain the membrane in the circulation space since the membrane is held only at the level of its outer peripheral edge.

According to a first variant of the embodiment with discoidal geometry, the first end of the membrane which is situated on the side of the inlet orifice, to which the excitation force is applied, may be a central edge of the membrane, whereas the second end of the membrane which is situated on the side of the outlet orifice may be an outer peripheral edge of the membrane. This arrangement may correspond to a centrifugal configuration of the pump, wherein the fluid circulates from the centre towards the periphery of the membrane.

According to a second variant of the embodiment with discoidal geometry, the first end of the membrane which is situated on the side of the inlet orifice, to which the excitation force is applied, may be an outer peripheral edge of the membrane, whereas the second end of the membrane which is situated on the side of the outlet orifice may be a central edge of the membrane. This arrangement may correspond to a centripetal configuration of the pump, wherein the fluid circulates from the periphery towards the centre of the membrane. This centripetal configuration may concentrate energy from the periphery towards the centre of the circulation space, thus making it possible to obtain pressure gradients which are compatible with those required in industrial applications. This centripetal configuration may also make it possible to operate with smaller amplitudes of excitation at the level of the outer peripheral edge of the membrane, and thus to limit the damage to fragile fluids.

According to a particular embodiment, the intake and delivery orifices of the pump body may open into the container in the vicinity of a lateral wall of the container. This may provide good circulation of fluid in the entire volume of the container, and in particular along the lateral walls of the container, in order to prevent particles from stagnating on these walls, while avoiding the appearance of dead zones in the container, i.e. of zones in which the fluid is not displaced.

In an embodiment, the pump body comprises a plurality of intake orifices and a plurality of delivery orifices, the intake orifices alternating angularly with delivery orifices in a circumferential direction of the pump body. Such an alternating arrangement of the intake and delivery orifices of the pump body may induce more homogeneous displacement of fluid in the volume of the container, and assists efficient mixing.

According to one embodiment, each delivery orifice is a peripheral orifice of the pump body, whereas each outlet orifice of the circulation space is a central orifice of the pump body, the pump body comprising a redirection part for redirecting fluid coming from each outlet orifice towards at least one delivery orifice. This configuration may promote the circulation of fluid at the periphery of the container, the fluid thus “lapping” the walls of the container, and preventing particles from adhering to the walls.

In an embodiment, each intake orifice is a peripheral orifice of the pump body, and forms an inlet orifice of the circulation space. The direct entry of fluid into the circulation space through the intake orifices of the pump body may make it possible to limit the size of the container-mixer.

According to one embodiment, the pump body comprises two walls (e.g., rigid walls) opposite one another, which may define between them the circulation space, the membrane being substantially in the shape of a disc, and held in the circulation space substantially parallel to the two walls. As previously stated, in this embodiment with discoidal geometry, each inlet orifice of the circulation space may open into the circulation space in the vicinity of the periphery of the membrane, whereas each outlet orifice of the circulation space opens into the circulation space in the vicinity of a central area of the membrane, such as to create an effect of concentration of the fluid displacement energy from the periphery towards the centre of the pump.

Irrespective of the geometry of the membrane, the membrane may comprise orifices, such that the fluid can pass on both sides of the membrane in the circulation space. Thus, it may be possible to exploit the entire volume of the pump body to transfer the mixing energy. In particular, in an embodiment with discoidal geometry, the membrane may comprise at least one peripheral orifice and at least one central orifice.

According to one embodiment, the pump body comprises a first plate and a second plate forming two, preferably rigid, walls opposite one another which define between them the circulation space, the first plate comprising the intake and delivery orifices which open into the inner volume of the container. The container can then be secured to the first plate, such that the circulation space is on the exterior of the container. As a variant, the container can be secured to the second plate, such that the circulation space is in the inner volume of the container. According to yet another variant, the container can be secured between the first and second plates, with the circulation space then corresponding to the volume of the container between the plates. In an embodiment, the second plate comprises a drainage orifice of the container-mixer, which opens on the exterior of the container.

The container can be secured to the pump body by any method of permanent or semi-permanent connection, such as by adhesive bonding, overmoulding, or welding. As a variant, the container can be secured to the pump body in a detachable manner, such as for example by screwing a threaded part of the pump body into a complementary tapped part which passes through a wall of the container.

The transverse cross section of the circulation space of the pump of a container-mixer according to the invention, taken perpendicularly to the direction of circulation, can be globally constant, increasing or decreasing from the inlet orifice of the circulation space towards the outlet orifice of the circulation space. In particular, in the case of a membrane with discoidal geometry, the thickness of the circulation space can be globally constant, increasing or decreasing from the periphery of the membrane towards a central area of the membrane. A configuration in which the transverse cross section of the circulation space is globally increasing from the inlet orifice towards the outlet orifice may make it possible to ensure a substantial fluid delivery at the level of the outlet orifice. A configuration in which the transverse cross section of the circulation space is globally decreasing from the inlet orifice towards the outlet orifice may make it possible to assist the propagation of waves from the end which is subjected to the excitation force, towards the other end of the membrane.

According to one aspect of the invention, the pump comprises a rigid support, which is secured to the end of the membrane which is intended to be subjected to the excitation force, and at least a projecting part of which passes in a sealed manner towards the exterior of the pump body, the actuating device being configured to act on this projecting part of the support, such as to generate in an alternating manner the excitation force at the end of the membrane. The support may be based on or made of a composite material with a polymer matrix, which in particular is selected from amongst polyphenylene sulphide (PPS), polypropylene, polycarbonate, which matrix is reinforced by fibres, in particular glass fibres.

According to one embodiment, the membrane is overmoulded on the support. This may save time in assembly of the pump, while improving the adhesion and coupling between the membrane and the support.

According to one aspect of the invention, the pump of the container-mixer is made entirely of polymer material(s), optionally fibre-reinforced in the case of those parts of the pump that perform a mechanical function, such as the support. By way of non-limiting example, the pump body can be made of polyolefin or polycarbonate; the support can be made of polyphenylene sulphide (PPS), polypropylene or polycarbonate reinforced by glass fibres; the membrane can be made of a silicone elastomer, polyurethane or rubber. Such a pump made entirely of polymer material may reduce the manufacturing cost of the container-mixer, while limiting its weight. In addition, when such a pump made of polymer material is associated with a container also made of polymer material, there are no metal parts in contact with the fluid or fluids to be mixed, which may be advantageous in the case of mixing of aggressive fluids liable to attack metallic materials or of fluids sensitive to metal pollution.

An embodiment of the invention proposes a mixer device comprising, on the one hand, a container-mixer comprising a container and a membrane pump and, on the other hand, an actuating device for actuation of the membrane. According to an embodiment, the container-mixer comprising the container and the membrane pump is disposable, in particular single-use, whereas the actuating device is durable and can be coupled in succession to several container-mixers. In an embodiment, the coupling element is adapted to selectively assemble or disassemble the actuating device relative to the membrane and/or the support of the membrane of the pump. In this manner, the actuating device of the container-mixer is operable to actuate/excite in turn membranes of different pumps. This embodiment may be particularly useful when each pump is associated with a corresponding container to form a disposable assembly, the actuating device then being operable to actuate, one after the other, pumps of several disposable assemblies.

In an embodiment, the container-mixer comprising the container and the membrane pump is preassembled such that the container and the pump body, which are in direct communication with one another, have a sterile inner volume.

Within the context of the invention, the actuating device can comprise at least one linear electromagnetic actuator supplied with an alternating current. As a variant, the actuating device can comprise at least one mechanical actuator, such as for example a connecting rod-crank actuator motorized by a variable speed gear motor.

According to one embodiment, the container comprises a flexible material. The container can then be flattened onto itself when it is empty of content, which limits the size of the container-mixer. Examples of appropriate flexible polymer materials for the container comprise in particular, in a non-limiting manner, polyethylene, polypropylene, polyvinylidene chloride (PVDC), nylon, ethylene vinyl alcohol copolymer (EVOH), fluorinated polymers such as ethylene tetrafluoroethylene (ETFE), polyvinylidene fluoride (PVDF), fluorinated ethylene-propylene copolymers (FEP). Here, “fluorinated polymer” refers to any polymer having in its chain at least one monomer chosen from compounds containing a vinyl groupcapable of opening to polymerize, and which contains, directly attached to this vinyl group, at least one fluorine atom, a fluoroalkyl group or a fluoroalkoxy group. Certain fluorinated polymers have the advantage of being permeable to gases, which can be exploited in order to ensure introduction of aeration gas into the container, in particular in the case of a bioreactor.

According to one aspect of the invention, the container-mixer comprises at least one orifice, preferably a sterile orifice, for filling of the container-mixer, which can be an orifice pierced in a wall of the container or an orifice of the pump body.

According to another aspect of the invention, the pump body of the container-mixer defines a drainage orifice for draining of the container-mixer, which opens on the exterior of the container. It is thus possible to empty the container-mixer through an integral part of the pump body. In an embodiment, the draining of the container-mixer may be passive, without the pump being actuated. In another embodiment, draining of the container-mixer may be active, with the pump actuated to encourage the draining.

In an embodiment, the container-mixer may comprise a control element for selectively controlling the passage of fluid through the drainage orifice according to a measured parameter representative of the quality of the mixing. As a parameter representative of the quality of the mixing, there may be an actuation time of the pump and/or a parameter representative of the fluidity of the fluid mixture. Since the excitation force depends on the fluidity of the mixture, the evolution over time of the excitation force can for example be measured and the draining can be selectively controlled as a function of this evolution. For example, the evolution of the excitation force can be measured by measuring the energy consumption required for the operation of the actuating device. As a variant, the quality of the mixing can be measured directly in the fluid, in particular by establishing a steady state of a parameter representative of the mixing rate, such as the pH, the conductivity, or any other quantity which makes it possible to access a concentration.

According to one feature, the container-mixer comprises a rigid framework to contain the container, which makes it possible to contain and support the walls of the container in the state in which it is full and during the mixing.

According to one embodiment, the container-mixer comprises at least one sensor for measurement of a parameter which is representative of the mixing rate in the container, such as the pH, the conductivity, or any other quantity which makes it possible to access a concentration. This or these sensor(s) may be in feedback connection with the actuating device.

In the case of a bioreactor, the container-mixer may comprise at least one sensor for measurement of the level of growth of the organisms in suspension, such as sensors for measurement of the level of O₂, the level of CO₂, the level of nutritive substances (sugar), the pH. The container-mixer can also comprise at least one element for introduction of aeration gas into the container, in particular dioxygen. The element for introduction of aeration gas can be formed by a tube, the wall of which allows aeration gas bubbles to pass through, with this tube entering the container through an orifice pierced in a wall of the container or an orifice of the pump body. As a variant, the element for introduction of aeration gas can be formed directly by one or more walls of the container made of a material permeable to the aeration gas, for example fluorinated ethylene-propylene copolymer (FEP).

### BRIEF DESCRIPTION OF THE DRAWINGS

The features and advantages of the invention will become apparent from the following description of two embodiments of a container-mixer according to the invention, provided purely by way of example and with reference to the attached drawings in which:

FIG. 1 includes a perspective view with partial cut away of a container-mixer according to a first embodiment of the invention;

FIG. 2 includes a cross section according to the planes II-II of FIG. 1;

FIG. 3 includes a perspective view of an assembly comprising the container-mixer of FIG. 1 and an actuating device;

FIG. 4 includes a perspective view with partial cut away of the container-mixer in a configuration coupled with the actuating device;

FIG. 5 includes a view on an enlarged scale of the detail V of FIG. 4;

FIG. 6 includes a perspective view of the upper plate of the container-mixer of FIGS. 1 to 5;

FIG. 7 includes a perspective view of the membrane of the container-mixer of FIGS. 1 to 5;

FIG. 8 includes a view similar to FIG. 1 for a container-mixer according to a second embodiment of the invention; and

FIG. 9 includes a cross section according to the planes IX-IX of FIG. 8.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other embodiments can be used based on the teachings as disclosed in this application.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single item is described herein, more than one item may be used in place of a single item. Similarly, where more than one item is described herein, a single item may be substituted for that more than one item.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the fluid mixing arts.

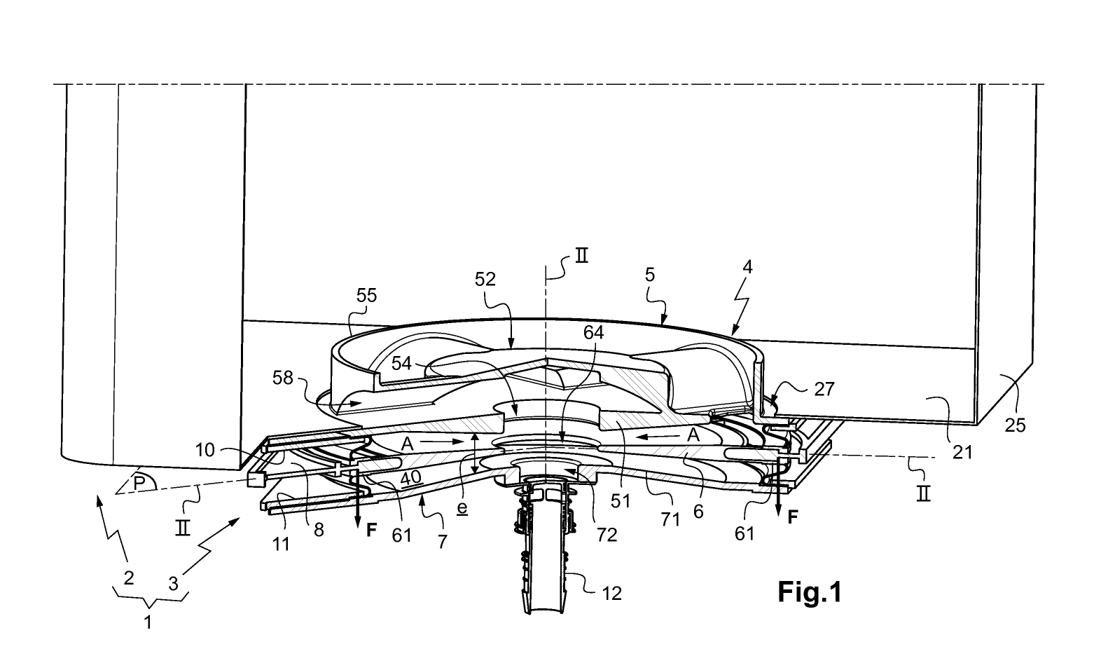

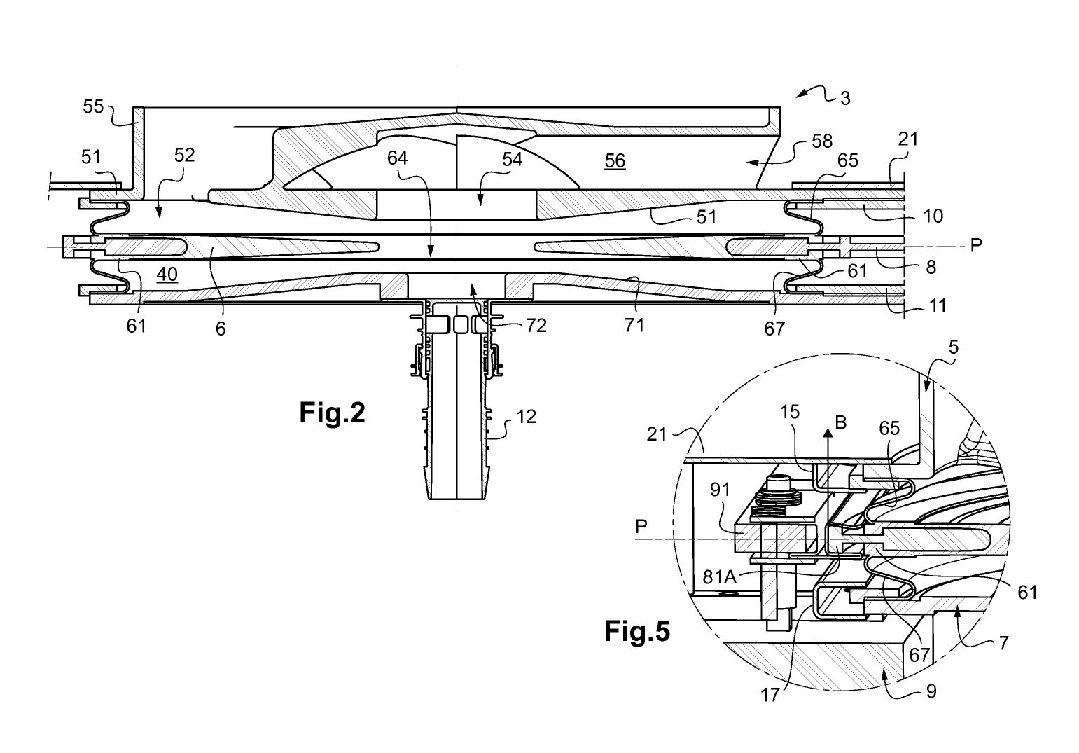

In the first embodiment represented in FIGS. 1 to 7, the container-mixer 1 comprises a bag 2 made of a flexible polymer material and a pump 3, the pump body 4 of which is secured to the bag 2. In this embodiment, the bag 2 is, for example, constructed on the basis of a multilayer polymer comprising the superposition of a layer of nylon, which provides the bag with properties of mechanical strength; a layer of polyethylene, which forms a moisture barrier; and a layer of polyvinyl alcohol PVOH, which forms a barrier against gases such as dioxygen and carbon dioxide. The bag 2 may include at least one sterile orifice 23 for filling the bag. The bag 2 may also include an opening 27 for receiving the pump body 4. In an embodiment, the at least one filling orifice 23 is provided in an upper 22 or lateral 25 wall of the bag 2, whereas the opening 27 for receiving the pump body 4 is provided in the vicinity of a bottom wall 21 of the bag. The capacity of the bag 2 is suited to the desired application. In a particular embodiment, the bag 2 can have a capacity in the range of 0.5 L and 5000 L, such as in a range of 10 L and 5000 L. In one embodiment, the assembly comprising the bag 2 and the pump 3 is sterile, and single-use.

The pump body 4 can include two plates, i.e. an upper plate 5 and a lower plate 7, which define between them a fluid circulation space 40, in the shape of a disc. The plates 5 and 7 are coupled to one another at their periphery, with interposition of a deformable membrane 6 which is designed for propulsion of fluid, and is also in the shape of a disc. In an embodiment, the plates 5 and 7 are made of a polymer material, for example of polypropylene. The plates 5 and 7 may be obtained by moulding, such as for example, by injection moulding.

Referring to FIGS. 1 and 6, the upper plate 5 of the pump body comprises a rigid wall 51 and a ring 55 which projects relative to the wall 51. The wall 51 can include a central orifice 54 as well as a plurality of peripheral orifices 52 situated in the vicinity of the junction between the wall 51 and the ring 55. The peripheral orifices 52 are provided for the intake of fluid into the pump body 4. In the vicinity of the junction between the wall 51 and the ring 55, the upper plate 5 can also comprise a plurality of peripheral orifices 58, which are designed for the delivery of fluid from the pump body 4. In an embodiment, the intake orifices 52 alternate angularly with the delivery orifices 58 in a circumferential direction of the body 4. In addition, the upper plate 5 can comprise a plurality of channels 56 which each connect the central orifice 54 and one of the delivery orifices 58. These channels 56 may be configured to ensure redirection of fluid from the central orifice 54 to the delivery orifices 58. In an embodiment, the upper plate 5 comprises four intake orifices 52, four delivery orifices 58, and four redirection channels 56.

The lower plate 7 can include a rigid wall 71 provided with a central orifice 72. The central orifice 72 may be configured for the drainage of fluid out of the pump body 4. For this purpose, the orifice 72 may be connected to a connection 12 which is adjustable between a closed configuration for closure of the orifice 72, and an open configuration for drainage of fluid through the orifice 72.

In an embodiment, assembly between the bag 2 and the pump body 4 is obtained by making the ring 55 of the upper plate 5 pass into the opening 27 of the bag, such that it projects into the inner volume of the bag, and by securing in a sealed manner the wall 51 of the upper plate to the bottom wall 21 of the bag, around the opening 27. The connection between the wall 51 of the upper plate and the bottom wall 21 of the bag can be obtained by any appropriate method, in particular by adhesive bonding, overmoulding, or welding. In the configuration in which the bag 2 is assembled with the pump body 4, the intake 52 and delivery 58 orifices of the pump body can open in the interior of the bag 2, such that a fluid present in the bag 2 can circulate directly and without a duct between the bag and the pump body. In addition, the connection 12 which is connected to the drainage orifice 72 may open on the exterior of the bag 2, such as to permit drainage of the bag 2.

In the pump body 4, the walls 51 and 71 of the plates 5 and 7 may be opposite one another, and define between them the fluid circulation space 40. The intake orifices 52 of the upper plate 5 may form inlet orifices for letting fluid into the circulation space 40, and the central orifice 54 of the upper plate 5 forms an outlet orifice for letting fluid out of the circulation space 40. The fluid may thus circulate in the circulation space 40 in a radial direction A, from the peripheral inlet orifices 52 to the central outlet orifice 54.

The membrane 6, which may be a flexible sheet of elastomeric material, for example silicone in this embodiment, has a mean plane P, and may be kept under tension in the circulation space 40, parallel to the direction A. As illustrated in FIG. 7, a peripheral end 61 of the membrane 6 is secured to a rigid support 8. In an embodiment, the support 8 is made of a composite material with a polymer matrix, for example, in this embodiment, polyphenylene sulphide (PPS) reinforced by glass fibres. As for the plates 5 and 7, the support 8 may be obtained by moulding, such as by injection moulding. In addition, the membrane 6 may be assembled to the support 8 by overmoulding or by two-shot moulding.

The membrane 6 may comprise two peripheral extensions 65 and 67 which extend from the peripheral end 61 of the membrane in the direction of the plates 5 and 7. The upper extension 65 may provide a sealed connection with the wall 51 of the upper plate 5, whereas the lower extension 67 may provide a sealed connection with the wall 71 of the lower plate 7. In this way, the extensions 65 and 67 may define the circulation space 40 circumferentially. Each extension 65 or 67 of the membrane may be secured to the corresponding wall 51 or 71 by two blocking rings, respectively an upper ring 10 and a lower ring 11. In an embodiment, the blocking rings are made of a composite material with polymer matrix, for example in this embodiment polyphenylene sulphide (PPS) reinforced by glass fibres.

In an embodiment, the membrane 6 comprises a central orifice 64, and a plurality of peripheral orifices 62, which are situated radially towards the interior relative to the peripheral extensions 65 and 67. Thus, the fluid may circulate in the circulation space 40 on both sides of the membrane 6, i.e. both in the volume defined between the membrane 6 and the upper plate 5 and in the volume defined between the membrane 6 and the lower plate 7.

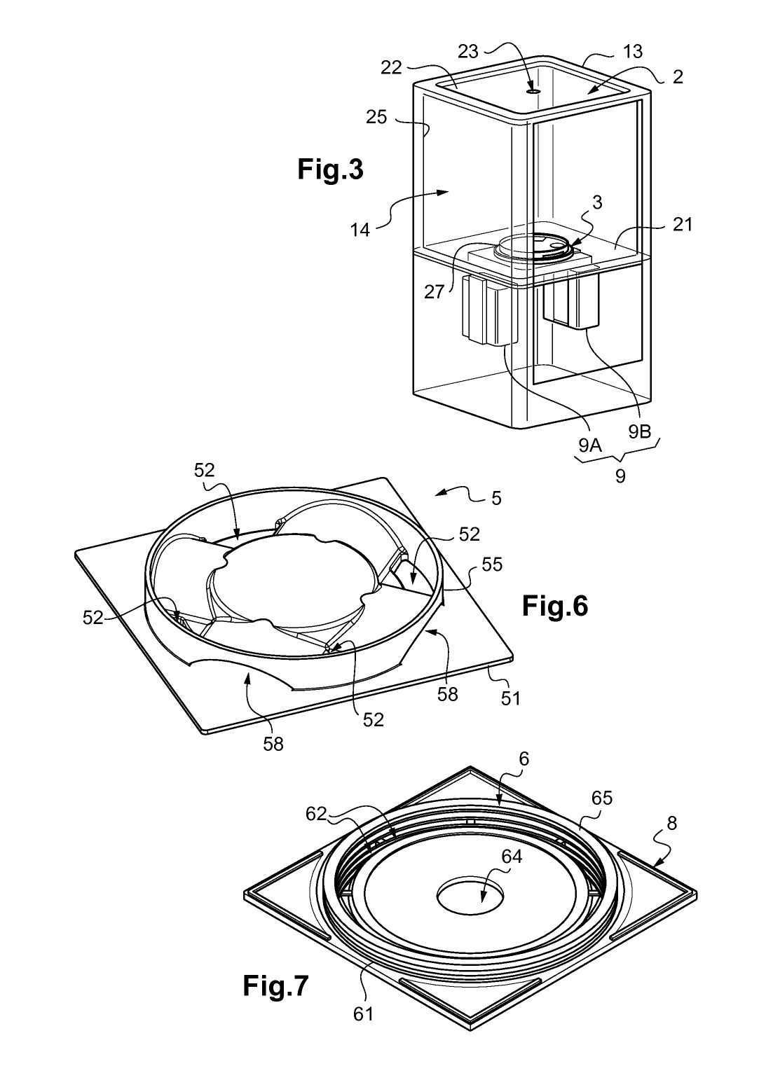

Referring to FIGS. 3 to 5, the support 8 to which the membrane 6 is secured comprises a peripheral part 81 which projects towards the exterior of the pump body 4. This peripheral part 81 may be configured to be connected to an actuating device 9, which, in this embodiment, comprises two linear electromagnetic actuators 9A and 9B. Each actuator 9A or 9B, when it is supplied with an alternating current, may give rise to alternating displacement in translation of a mobile part 91, which is derived from the occurrence of Laplace forces within the actuator. The actuators 9A and 9B may be disposed such that the mobile parts 91 of the two actuators are secured to two opposite sides 81A and 81B of the peripheral part 81 of the support 8.

As illustrated in detail in FIG. 5, for each actuator 9A or 9B, the connection between the mobile part 91 of the actuator and the corresponding side 81A or 81B of the support 8 is obtained by inserting the side of the support 8 in a rail 18 which is integral with the mobile part 91. The mobile parts 91 of the two actuators 9A and 9B are then able to impart to the support 8 a movement of translation according to a direction B which is substantially perpendicular to the mean plane P of the membrane 6. Thus, the actuating device 9 makes it possible to generate alternately, at the peripheral end 61 of the membrane 6, an excitation force F which is substantially perpendicular to the mean plane P of the membrane 6. The constitutive material and the dimensions of the support 8 are selected such that the support 8 has sufficient strength to guarantee that the excitation force F applied to the peripheral end 61 of the membrane 6 is substantially the same around the entire periphery of the membrane, even if the actuators 9A and 9B act only on two opposite sides of the support 8.

In an embodiment, in order to guarantee good propagation of waves from the peripheral end 61 of the membrane 6 which is subjected to the excitation force F towards the end of the membrane which delimits the central orifice 64, the membrane 6 has a thickness e which decreases from its peripheral end 61 towards its central orifice 64. It is also possible to assist good propagation of waves from the periphery towards the central orifice 64 of the membrane 6, while maintaining a substantially constant cross section of passage of fluid, by taking advantage of the geometry of the circulation space 40, in particular by ensuring that the thickness e of the circulation space 40 decreases from the peripheral end 61 of the membrane towards the central orifice 64 of the membrane.

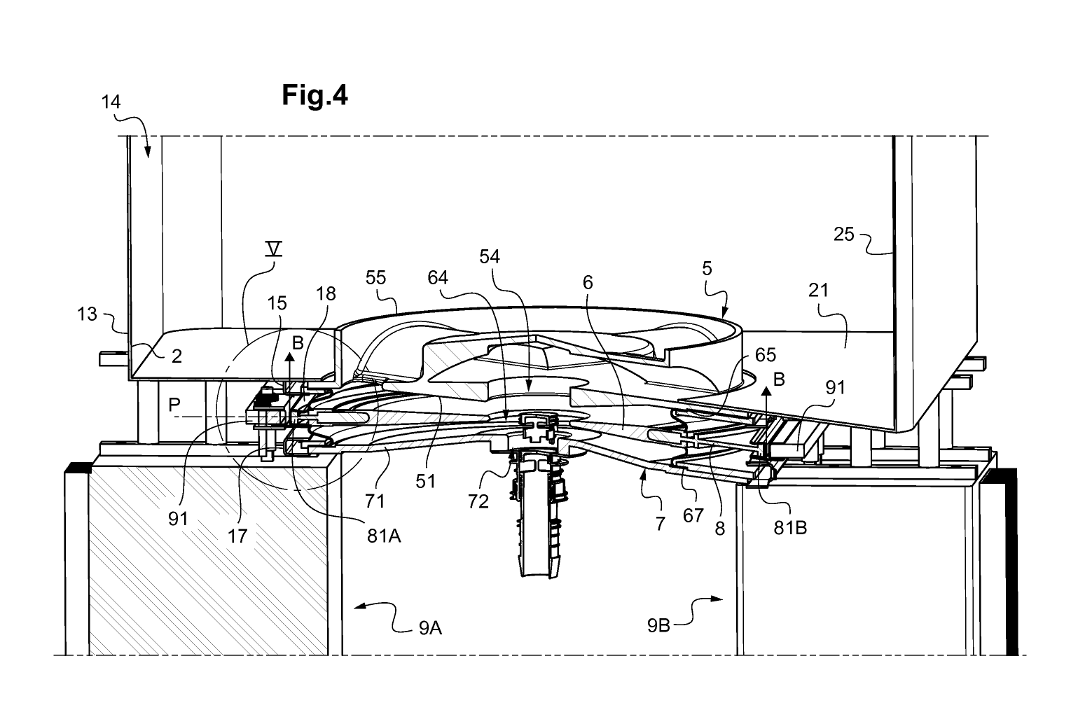

Referring to FIGS. 4 and 5, in order to immobilize the upper and lower plates while facilitating the positioning of the container-mixer 1 relative to the actuating device 9, in addition to the pair of mobile rails 18 which can receive the support 8 and drive it in translation, two additional pairs of fixed rails 15 and 17 are provided, situated on both sides of the pump body 4, while being parallel to the rails 18. The rails 15 may receive the periphery of the upper plate 5, while the rails 17 may receive the periphery of the lower plate 7.

Referring to FIG. 3, a rigid framework 13 can be provided to support the actuating device 9 and the positioning rails 15, 17 and 18. The rigid framework 13 may define a receptacle 14 to receive the bag 2. The container-mixer 1 can thus easily be positioned in the framework 13, in a detachable manner. In addition, the receptacle 14 allows the bag 2 to be retained when it is full. The framework 13 can also bear electronic control elements for controlling the actuating device 9, and a further element for monitoring the quality of the mixing.

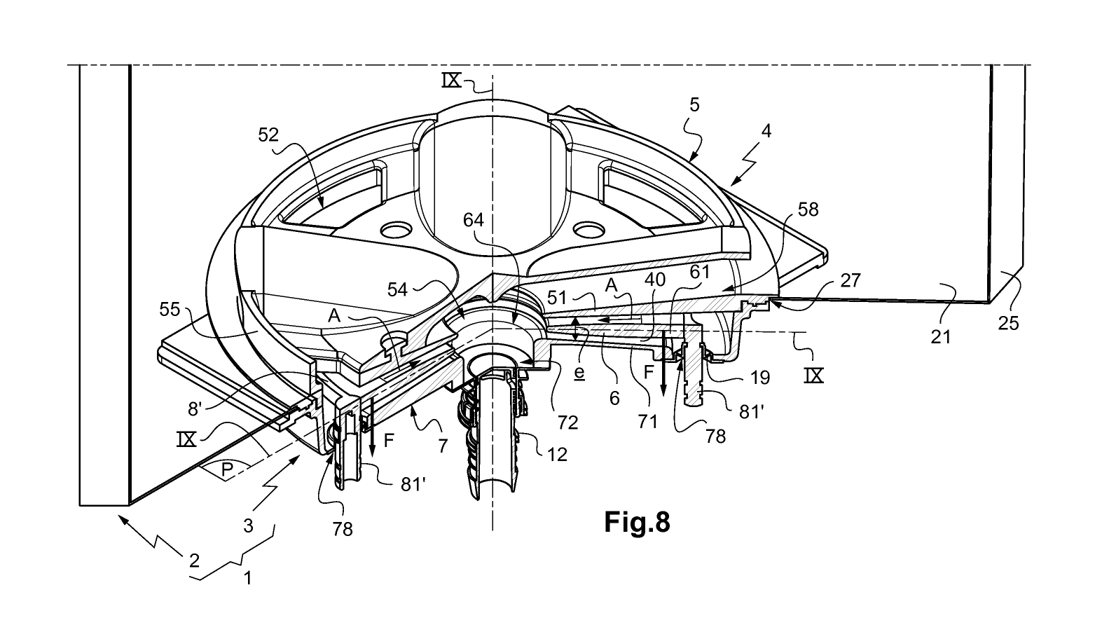

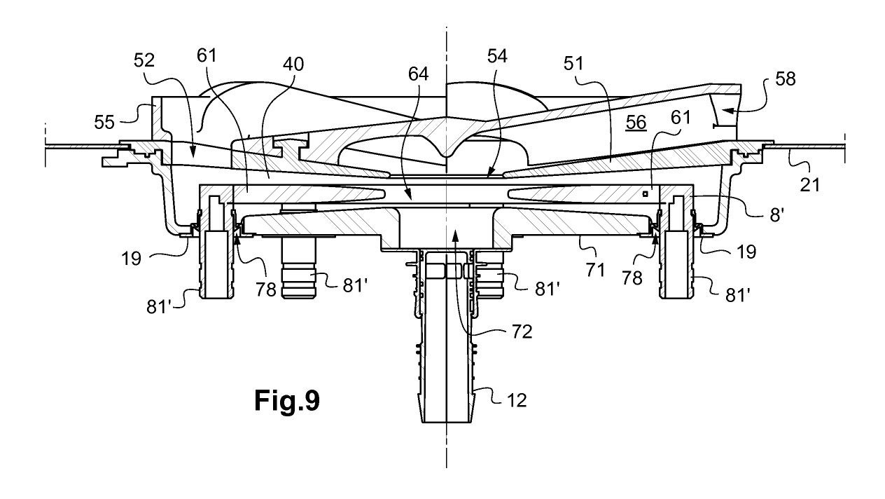

In the second embodiment illustrated in FIGS. 8 and 9, the elements which are similar to those of the first embodiment bear identical references. The container-mixer 1 of this second embodiment differs from that of the first embodiment only in the method implemented to connect the peripheral end 61 of the membrane 6 to the actuating device 9. In this second embodiment, the rigid support 8′ to which the end 61 of the membrane is secured does not extend radially relative to the plates 5 and 7, but comprises a plurality of peripheral legs 81′ distributed circumferentially, which project towards the exterior of the pump body 4 through orifices 78 of the lower plate 7. In this embodiment, the support 8′ comprises six peripheral legs 81′ which pass into six orifices 78 in the lower plate 7. Seals 19 may be provided in each orifice 78. By way of example, in this embodiment, the support 8′ is made of polycarbonate, and the seals 19 are made of silicone, and are overmoulded on the legs 81′ of the support 8′.

The peripheral legs 81′ of the support 8′ are adapted to be connected to an actuating device 9, which, as in the first embodiment, can comprise one or more linear electromagnetic actuators, the mobile parts 91 of which can be secured to the peripheral legs 81′, for example by being snapped into the inner volume of the peripheral legs 81′. This second embodiment may allow direct assembly of the upper plate 5 and the lower plate 7 at their periphery, and limit the radial size of the container-mixer. In addition, in this second embodiment, it may be possible to use a support 8′ which is less rigid than the support 8 of the first embodiment, since the actuators act more homogeneously at the periphery of the support. The mobile mass of the support 8′ is also smaller than in the first embodiment, which makes it possible to provide a smaller force exerted by the actuators on the support.

As is apparent from the foregoing description, a container-mixer according to the invention may obtain efficient displacement of fluids so that they can be mixed, both for small and large volumes, while limiting the shearing stresses generated in the fluids, thus making it possible to avoid damage to their components. In an embodiment, the invention proposes a mixer device comprising, on the one hand, a container-mixer which is sterile and disposable, comprising a container and a membrane pump, and, on the other hand, an actuating device for actuation of the vibration of the membrane, which is durable and can be coupled in succession with a plurality of container-mixers. With a container-mixer according to the invention, the risks of leakage and contamination are limited, in particular because of the absence of dynamic seals subjected to stress by a rotary member.

The invention is not limited to the examples described and represented.

In particular, as previously stated, the membrane of the pump can have a geometry other than discoidal, and in particular a strip geometry or tubular geometry. In addition, a single face of the membrane can be used to displace the fluid, which would be the case for example in the above-described embodiments if the membrane did not comprise peripheral orifices 62 for passage of the fluid on both sides of the membrane.

In addition, the container can be rigid instead of being flexible. The container can also include a combination of a rigid container and a flexible container, where the rigid container can support the flexible container. The connection between the pump and the container can also be a reversible connection, instead of a permanent or semi-permanent connection as previously described. In particular, it can be a connection which is screwed between a tapped unit fitted in the opening 27 of the container, and a corresponding threaded part provided in an orifice of the pump body.

According to a variant not represented, the container can be secured to the lower plate 7 instead of the upper plate 5, the circulation space then being situated in the inner volume of the container. According to another variant, the container can be secured between the upper plate 5 and the lower plate 7, the circulation space then corresponding to the volume of the container between the plates 5 and 7. In addition, the geometry of the pump body can be different from that described and represented, for example in terms of numbers of orifices or structure of the plates. In particular, the upper plate 5 can be modified so as not to have any flatness or other surface which can assist the occurrence of dead zones of fluid.

As an option, a container-mixer according to the invention can comprise a plurality of pumps for a single container, or conversely, a plurality of containers for a single pump. It is also possible for a single pump to comprise several membranes arranged in parallel so as to undulate together, in the circulation space, under the effect of the excitation force F and arranged to force a flow of fluid through the circulation space from the inlet orifice of the circulation space towards the outlet orifice of the circulation space. Actuating devices other than the linear electromagnetic actuators previously described can also be used within the context of the invention. In particular, the structure of the electromagnetic actuators can be modified such that a winding is present around the pump body, so as to induce displacement of the mobile part of each actuator inside the pump body. This configuration makes it possible to have a pump body which is completely closed without a part 81 or 81′ passing to the exterior of the pump body, which is particularly advantageous for the sealing. As a variant, as already stated, the electromagnetic actuators can also be replaced by other types of actuators, and in particular mechanical actuators.

In addition, the invention may be applicable for mixing of all types of fluids, including fluids which are fragile or charged with particles, in particular biological or pharmaceutical fluids. The invention is well suited for mixing of non-Newtonian fluids, for which shearing is to be controlled, for example for mixing of shear-thinning or shear-thickening fluids, or for mixing of fluids which can clot irreversibly under the effect of shearing.

Many different aspects and embodiments are possible. Some of those aspects and embodiments are described below. After reading this specification, skilled artisans will appreciate that those aspects and embodiments are illustrative and do not limit the scope of the present invention. Embodiments may be in accordance with any one or more of the items as listed below.

Item 1. A container-mixer comprising:
a container which is designed to receive at least one fluid; and
a pump comprising a pump body which defines at least one fluid intake orifice and at least one fluid delivery orifice,
characterized in that the at least one intake orifice and the at least one fluid delivery orifice of the pump body open into the interior of the container such that the fluid circulates directly and without a duct between the container and the pump body, the pump body defining a circulation space for circulation of fluid in a direction of circulation (A) from the at least one inlet orifice of the circulation space towards an outlet orifice of the circulation space, the pump comprising a deformable membrane which is held in the circulation space substantially parallel to the direction of circulation (A), the membrane being actuated so as to vibrate.

Item 2. The container-mixer according to item 1, wherein the membrane is actuated at one end thereof situated on the side of the at least one inlet orifice, so that an undulation of the membrane is propagated from the one end to another end of the membrane situated on the side of the outlet orifice.

Item 3. The container-mixer according to either of items 1 or 2, comprising a coupling element adapted to couple the membrane with an actuating device, the actuating device being adapted to vibrate the membrane.

Item 4. The container-mixer according to item 3, wherein the pump comprises a rigid support secured to one end of the membrane, at least one part of which passes in a sealed manner towards an exterior of the pump body, the actuating device being configured to act on the at least one part of the rigid support such as to generate, in an alternating manner, at the end of the membrane, the excitation force (F).

Item 5. The container-mixer according to either of items 3 or 4, wherein the actuating device comprises at least one linear electromagnetic actuator supplied with an alternating current.

Item 6. The container-mixer according to any of items 3, 4, or 5, wherein the coupling element is adapted to selectively assemble or disassemble the actuating device relative to the membrane of the pump.

Item 7. The container-mixer according to any of items 3, 4, 5, or 6, wherein the container-mixer further comprises at least one sensor for measurement of a parameter which is representative of the mixing rate in the container, which is in feedback connection with the actuating device.

Item 8. The container-mixer according to any one of the preceding items, wherein the pump body comprises walls which define between them the circulation space for circulation of fluid in the direction of circulation (A) from the at least one inlet orifice of the circulation space towards the at least one fluid outlet orifice, the membrane being held in the circulation space substantially parallel to the direction of circulation (A), the container-mixer comprising a coupling element adapted to couple the membrane with an actuating device, the actuating device being adapted to generate alternately, at one end of the membrane situated near the inlet orifice, an excitation force (F) substantially perpendicular to the direction of circulation (A).

Item 9. The container-mixer according to any one of the preceding items, wherein the at least one intake orifice and the at least one fluid delivery orifice open into the container near a lateral wall of the container.

Item 10. The container-mixer according to any one of the preceding items, wherein the at least one intake orifice alternates angularly with the at least one fluid delivery orifice in a circumferential direction of the pump body.

Item 11. The container-mixer according to any one of the preceding items, wherein the at least one fluid delivery orifice is a peripheral orifice of the pump body, wherein the outlet orifice of the circulation space is a central orifice of the pump body, the pump body comprising a redirection part for redirecting fluid coming from the at least one outlet orifice towards the at least one fluid delivery orifice.

Item 12. The container-mixer according to any one of the preceding items, wherein the at least one intake orifice is a peripheral orifice of the pump body and forms an inlet orifice of the circulation space.

Item 13. The container-mixer according to any one of the preceding items, wherein the pump body comprises two walls defining between them the circulation space, the membrane being substantially in the shape of a disc, and held in the circulation space substantially parallel to the walls.

Item 14. The container-mixer according to item 13, wherein each inlet orifice of the circulation space opens into the circulation space in the vicinity of the periphery of the membrane, whereas each outlet orifice of the circulation space opens into the circulation space in the vicinity of a central area of the membrane.

Item 15. The container-mixer according to either of items 13 or 14, wherein the membrane comprises at least one peripheral orifice and at least one central orifice.

Item 16. The container-mixer according to any of items 1 to 8, wherein the pump body comprises two walls defining between them the circulation space, the membrane being in the form of a substantially parallelepiped strip and held in the circulation space such that the walls of the circulation space are disposed facing main surfaces of the membrane.

Item 17. The container-mixer according to any of items 1 to 8, wherein the pump body defines a tubular circulation space, the membrane having a tubular shape and being held in the tubular circulation space.

Item 18. The container-mixer according to any one of the preceding items, wherein the pump body comprises a first plate and a second plate forming two walls opposite one another and defining between them the circulation space, the first plate comprising the at least one intake orifice and the at least one fluid delivery orifice which open into the inner volume of the container.

Item 19. The container-mixer according to Item 18, wherein the container is secured to the first plate such that the circulation space is disposed at the exterior of the container.

Item 20. The container-mixer according to item 18, wherein the container is secured to the second plate such that the circulation space is disposed in the inner volume of the container.

Item 21. The container-mixer according to any one of the preceding items, wherein the container is secured to the pump body in a detachable manner.

Item 22. The container-mixer according to any one of the preceding items, wherein the container comprises a flexible material.

Item 23. The container-mixer according to any one of the preceding items, wherein an assembly comprising the container and the pump is sterile and/or disposable.

Item 24. The container-mixer according to any one of the preceding items, wherein the container-mixer comprises at least one orifice for filling of the container-mixer.

Item 25. The container-mixer according to any one of the preceding items, wherein the pump body defines at least one drainage orifice for draining of the container-mixer, which opens on the exterior of the container.

Item 26. The container-mixer according to any one of the preceding items, wherein the container-mixer comprises a rigid framework to contain the container.

Item 27. The container-mixer according to any one of the preceding items, wherein the container-mixer comprises at least one element for introduction of aeration gas into the container.

Item 28. A container-mixer comprising:
a container which is designed to receive at least one fluid, wherein the container is made of flexible material; and
a pump comprising a pump body which defines at least one orifice for intake of fluid and at least one orifice for delivery of fluid,
wherein the orifices for intake and delivery of the pump body open into the interior of the container, the pump comprising a deformable membrane which is retained in a circulation space generally parallel to a direction of circulation (A), and wherein the pump is adapted to vibrate the deformable membrane.

Item 29. A container-mixer comprising:
a container adapted to receive at least one fluid; and
a pump comprising a pump body including at least one orifice for intake of fluid and at least one orifice for delivery of fluid, wherein the pump body defines a space for circulation of fluid according to a direction of circulation (A) from an inlet orifice in the circulation space to an outlet orifice out of the circulation space, the pump comprising a deformable membrane retained in the circulation space generally parallel to the direction of circulation (A), wherein the orifices for intake and delivery open into an interior of the container such that the fluid circulates directly and without a duct between the container and the pump body, and wherein the container-mixer comprises a coupling element disposed between the membrane and an actuating device which is adapted to generate alternately, at an end of the membrane situated in the vicinity of the inlet orifice, an excitation force (F) which is substantially perpendicular to the direction of circulation (A).

Item 30. The container-mixer according to Item 29, wherein the membrane is actuated at the end situated on the side of the inlet orifice, such that an undulation of the membrane is propagated from the end to another end of the membrane situated on the side of the outlet orifice.

Item 31. The container-mixer according to Item 29, wherein the intake and delivery orifices in the pump body open into the container in the vicinity of a lateral wall of the container.

Item 32. The container-mixer according to Item 29, wherein the pump body further comprises a plurality of intake orifices and a plurality of delivery orifices, the intake orifices alternating angularly with delivery orifices according to a circumferential direction of the pump body.

Item 33. The container-mixer according to Item 29, wherein each delivery orifice is a peripheral orifice in the pump body, whereas each outlet orifice of the circulation space is a central orifice in the pump body, the pump body comprising a part for redirection of fluid obtained from each outlet orifice towards at least one delivery orifice.

Item 34. The container-mixer according to Item 29, wherein the pump body further comprises two rigid walls opposite one another and defining therebetween the circulation space.

Item 35. The container-mixer according to Item 34, wherein the membrane comprises a disc retained in the circulation space parallel to the rigid walls.

Item 36. The container-mixer according to Item 35, wherein each inlet orifice of the circulation space opens into the circulation space in the vicinity of the periphery of the membrane, and wherein each outlet orifice of the circulation space opens into the circulation space in the vicinity of a central area of the membrane.

Item 37. The container-mixer according to Item 35, wherein the membrane comprises at least one peripheral orifice and at least one central orifice.

Item 38. The container-mixer according to Item 29, wherein the pump body further comprises a first plate and a second plate, the first and second plates comprising two rigid walls opposite one another and defining therebetween the circulation space, wherein the first plate comprises the intake and delivery orifices which open into the inner volume of the container.

Item 39. The container-mixer according to Item 38, wherein the container is integral with the first plate such that the circulation space is on an exterior of the container.

Item 40. The container-mixer according to Item 38, wherein the container is integral with the second plate such that the circulation space is in the inner volume of the container.

Item 41. The container-mixer according to Item 29, wherein the pump further comprises a rigid support integral with the end of the membrane and at least part of which passes in a sealed manner towards the exterior of the pump body.

Item 42. The container-mixer according to Item 29, wherein the container comprises a flexible material.

Item 43. The container-mixer according to Item 29, wherein the container-mixer comprises at least one orifice for filling of the container-mixer.

Item 44. The container-mixer according to Item 29, wherein the pump body defines at least one orifice for draining of the container-mixer, the at least one orifice for draining opening on the exterior of the container.

Item 45. The container-mixer according to Item 29, further comprising a rigid framework adapted to contain the container.

Item 46. The container-mixer according to Item 29, further comprising at least one sensor for measurement of a parameter representative of the mixing rate in the container, wherein the at least one sensor is in feedback with the actuating device.

Item 47. The container-mixer according to Item 29, further comprising at least one element for introduction of aeration gas into the container.

Item 48. A container-mixer comprising:
a container adapted to receive at least one fluid, wherein the container comprises a flexible material; and
a pump comprising a pump body defining at least one orifice for intake of fluid and at least one orifice for delivery of fluid,
wherein the orifices for intake and delivery of fluid open into an interior of the container, wherein the pump further comprises a deformable membrane retained in a circulation space at an orientation generally parallel to a direction of circulation (A), and wherein the pump is adapted to vibrate the deformable membrane.

Certain features are, for clarity, described herein in the context of separate embodiments, may also be provided in combination in a single embodiment. Conversely, various features that are, for brevity, described in the context of a single embodiment, may also be provided separately or in any subcombinations.

Benefits, other advantages, and solutions to problems have been described above with regard to specific embodiments, However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or any change may be made without departing from the scope of the disclosure. Accordingly, the disclosure is to be regarded as illustrative rather than restrictive.

1. A container-mixer comprising:
a container which is designed to receive at least one fluid; and
a pump comprising a pump body which defines at least one fluid intake orifice and at least one fluid delivery orifice,
wherein the at least one intake orifice and the at least one fluid delivery orifice of the pump body open into the interior of the container such that the fluid circulates directly and without a duct between the container and the pump body, the pump body defining a circulation space for circulation of fluid in a direction of circulation (A) from the at least one inlet orifice of the circulation space towards an outlet orifice of the circulation space, the pump comprising a deformable membrane which is held in the circulation space substantially parallel to the direction of circulation (A), the membrane being actuated so as to vibrate.

2. The container-mixer according to claim 1, wherein the membrane is actuated at one end thereof situated on the side of the at least one inlet orifice, so that an undulation of the membrane is propagated from the one end to another end of the membrane situated on the side of the outlet orifice.

3. The container-mixer according to claim 1, comprising a coupling element adapted to couple the membrane with an actuating device, the actuating device being adapted to vibrate the membrane.

4. The container-mixer according to claim 3, wherein the pump comprises a rigid support secured to one end of the membrane, at least one part of which passes in a sealed manner towards an exterior of the pump body, the actuating device being configured to act on the at least one part of the rigid support such as to generate, in an alternating manner, at the end of the membrane, the excitation force (F).

5. The container-mixer according to claim 3, wherein the actuating device comprises at least one linear electromagnetic actuator supplied with an alternating current.

6. The container-mixer according to claim 3, wherein the coupling element is adapted to selectively assemble or disassemble the actuating device relative to the membrane of the pump.

7. The container-mixer according to claim 3, wherein the container-mixer further comprises at least one sensor for measurement of a parameter which is representative of the mixing rate in the container, which is in feedback connection with the actuating device.

8. The container-mixer according to claim 1, wherein the pump body comprises walls which define between them the circulation space for circulation of fluid in the direction of circulation (A) from the at least one inlet orifice of the circulation space towards the at least one fluid outlet orifice, the membrane being held in the circulation space substantially parallel to the direction of circulation, the container-mixer comprising a coupling element adapted to couple the membrane with an actuating device, the actuating device being adapted to generate alternately, at one end of the membrane situated near the inlet orifice, an excitation force (F) substantially perpendicular to the direction of circulation (A).

9. The container-mixer according to claim 1, wherein the at least one intake orifice and the at least one fluid delivery orifice open into the container near a lateral wall of the container.

10. The container-mixer according to claim 1, wherein the at least one intake orifice alternates angularly with the at least one fluid delivery orifice in a circumferential direction of the pump body.

11. The container-mixer according to claim 1, wherein the at least one fluid delivery orifice is a peripheral orifice of the pump body, wherein the outlet orifice of the circulation space is a central orifice of the pump body, the pump body comprising a redirection part for redirecting fluid coming from the at least one outlet orifice towards the at least one fluid delivery orifice.

12. The container-mixer according to claim 1, wherein the at least one intake orifice is a peripheral orifice of the pump body and forms an inlet orifice of the circulation space.

13. The container-mixer according to claim 1, wherein the pump body comprises two walls defining between them the circulation space, the membrane being substantially in the shape of a disc, and held in the circulation space substantially parallel to the walls.

14. The container-mixer according to claim 13, wherein the membrane comprises at least one peripheral orifice and at least one central orifice.

15. The container-mixer according to claim 1, wherein the pump body comprises two walls defining between them the circulation space, the membrane being in the form of a substantially parallelepiped strip and held in the circulation space such that the walls of the circulation space are disposed facing main surfaces of the membrane.

16. The container-mixer according to claim 1, wherein the pump body defines a tubular circulation space, the membrane having a tubular shape and being held in the tubular circulation space.

17. The container-mixer according to claim 1, wherein the pump body comprises a first plate and a second plate forming two walls opposite one another and defining between them the circulation space, the first plate comprising the at least one intake orifice and the at least one fluid delivery orifice which open into the inner volume of the container.

18. The container-mixer according to claim 17, wherein the container is secured to the first plate such that the circulation space is disposed at the exterior of the container.

19. The container-mixer according to claim 17, wherein the container is secured to the second plate such that the circulation space is disposed in the inner volume of the container.

20. The container-mixer according to claim 1, wherein the container comprises a flexible material.
